(19) United States
(12) Patent Application Publication
(10) Pub. No.: US 2013/0031467 A1
(43) Pub. Date: Jan. 31, 2013

(54) SO-CALLED HD-WEB METHOD FOR HIGH-DEFINITION AND ALL-SCREEN COMPATIBILE INTERNET CONTENTS

(71) Applicant: Romain Zylik, Paris (FR)

(72) Inventor: Romain Zylik, Paris (FR)

(21) Appl. No.: 13/640,655

(22) PCT Filed: Apr. 12, 2011
(86) PCT No.: PCT/FR2011/000214

§ 371 Date: Oct. 11, 2012

(30) Foreign Application Priority Data
Apr. 12, 2010 (FR) 10/01519
Apr. 27, 2010 (FR) 10/01794

(51) Int. Cl. G06F 17/00

(52) U.S. Cl. 715/234

(57) ABSTRACT

A collection of technical processes forming an HD-Web™ application, for use of proprietors hosting, on a server, contents such as a service or a website who wish to ensure perfect broadcasting and utilization of their contents regardless of the display sources and the sizes of screens on which they will be broadcast particularly when dealing with high-definition HD screens. The process greatly improving on these screens, the comfort and the experience of the user on account of web pages that hitherto do not utilize the whole display area available on large-size screens, or that are becoming ever smaller and difficult to read on screens with significant resolutions. The process being autonomous and operating in a transparent and nonintrusive manner on any internet site or service benefitting therefrom, thus guarantees the proprietor thereof that their contents will always be displayed perfectly regardless of the display sources and the screens publishing them.

This invention relates to a set of technical processes that makes it possible for the services, and for the websites using it, to make the contents of their pages optimized during their browsing on high-definition screens, while ensuring their compatibility on standard screens of different sizes and of lower resolutions.

The set of these technical processes implemented forms a web application (it involves neither a software package nor a program), we will call this invention subsequently in this document by the HD-Web™ application term; we will use the acronym HD for the term High-Definition, and we will speak of HD compatible, that is to say High-Definition compatible, service and/or website.

The emergence of high-definition and its appearance in the equipment of households with the purchasing of High-Definition screens, reputed to improve the visual comfort and the user experience during the displaying of a film, produces the opposite effect for the browsing of websites that then become smaller and more difficult to browse on HD screens (also with the appearance of considerable margins to the left and/or to the right of the screen, significantly degrading the visual display of the latter), indeed difficult to read on so-called full HD™¹ screens because of images and characters then becoming much too small. ¹ The term “full HD™” or “1080p” designating a resolution of 1920×1080 and “HD” or “720p” with a resolution at least equal to 1366×720 pixels being the commercial terms, we will no longer make this difference below, the first principle of this invention being to make possible a compatibility of the websites regardless of the screen definitions; this therefore relates to all sizes of screens present on the market.

Since all websites are currently optimized for a so-called standard screen resolution of 1024×768 pixels², their browsing on screens with higher resolutions whether they are HD or not is therefore obviously highly adversely affected. ² This standard resolution, being based on the available width for screens 1024 pixels wide after deduction of the margins due to the possible presence of a vertical scroll bar to the right of the screen, is estimated on average at 980 pixels.

As FIG. 1 shows, this drawback appears immediately with a screen resolution of 1280×1024 pixels, and the popularization of the HD screens in the coming years will only increase the extent of this problem that, for now, is still emerging.

The use of the HD-Web™ technology brings from now on a technical solution to this problem by making it possible for the households that have recent screens (whether they are HD or full HD™) to take advantage of high definition websites, while providing the possibility to the households that are not equipped with such screens to continue to display these same sites in a standard resolution as they do now, all this, of course, in a transparent and automatic manner without intervention either from the Internet user or from the publishing company of the site once the solution is put in place.

The websites using this invention will therefore be compatible, i.e., optimized for a display on all screens and regardless of their resolutions (see FIG. 3), a technical characteristic that we summarize under the website term HD compatible and that we have used at the beginning of this document.

N.B.: It is necessary to distinguish clearly this invention from the feature, present in certain software packages such as web browsers and that make it possible to enlarge or reduce the text, the images, or the pages of an Internet site (a function commonly designated by the term “zoom” or “magnifying glass”).

This kind of zooming feature not having in fact anything to do with this invention, neither with regard to its results (the zoom causing only the pixels of the screen to enlarge, by causing a blurred effect if the image is interpolated, or a pixelation effect if it is not interpolated) nor with regard to the technical processes that it uses: the zoom being a functionality of the software package or of the web browser, namely a so-called “client” technology that can at no time intervene on a “server” side, i.e., on the broadcast of the contents of itself depending on the screen on which it is used, in contrast with this invention.

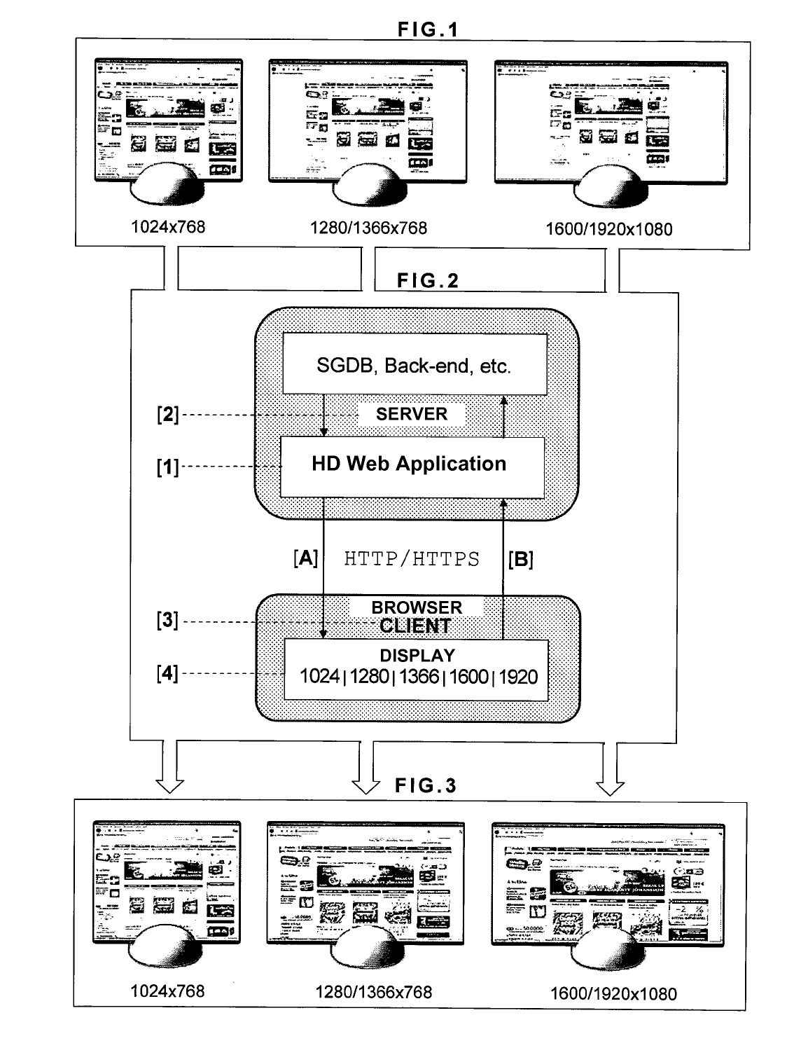

The process that forms the uniqueness of this invention, and whose principle is diagrammed in FIG. 2, shows in what way the HD-Web™ application, by means of the browser, communicates in real time to the server what contents to send depending on the resolution of the monitor where the service and/or the website is consulted.

This exclusive process opens new and varied perspectives since in addition to making possible the publishing of HD compatible websites, this solution will also make it possible for web services to broadcast different contents according to the screen on which it is displayed; thus, for example, an Internet user having an HD screen will be able to take advantage of high definition video excerpts or images and another having only a standard screen will look at these same excerpts in a more reduced resolution (or simple vignettes in the case of images), all this in a transparent and automatic way, a thing that is impossible to achieve with a common zoom function that will interpolate simply the image that is sent to it and will also require the intervention of the Internet user (a click in a menu or on a button of his browser, for example) and that, besides, inherently will be neither portable nor compatible since this functionality will depend on its presence or not on such and such web browser, in contrast with our invention that is not dependent on the client-side installed browser.

Moreover, the use of technical methods (that we will explain in detail in the following pages), developed specifically to render our invention equally independent of the technical environment of the service and/or website hosting it, shows that the latter will be completely separate and non-intrusive (i.e., it will not touch the source files of the service and/or of the website in question) once put in place on the server-side.

For these reasons, in addition to having a perfect client-side portability and compatibility (i.e., regardless of the equipment of the user: screen, operating system or web browser³), our HD-Web™ application will also be it on the server-side, thus guaranteeing a lasting utilization to the service and/or website hosting it. ³ Although in the context of a use in high definition, the presence of recent hardware is necessary, more thorough tests performed under older platforms and under different operating systems (WINDOWS-98®, WINDOWS-NT®, WINDOWS-2000®, WINDOWS-XP®, WINDOWS-VISTA®, WINDOWS-7®, MAC® OSX-PPC®/Intel® and Linux) as well as on the majority of web browsers on the market released between 2000 and 2010 (Internet Explorer®5/6/7/8/9, Netscape®4/5/6, Firefox®1/2/3, Opera®6/7/8/9/10/11, Safari®1/2/3/4/5, Google Chrome® and all other browsers based on the aforementioned engines) have shown that a piece of equipment dating from several years back is not harmful in any way to the proper functioning of this invention.

Before developing in detail the set of technical processes used in this invention, it is necessary for us to separate the technical processes that make up the invention from the technical processes that serve to implement and incorporate the latter according to specifications of the service or website concerned. We will thus define this set as being composed of two groups of distinct technical processes:

1) The first group forming the set of the technical processes common to the invention regardless of the technical environment of the client, the service, or the Website concerned, and forming what we will call the heart of the application.

2) The second group forming the set of accompanying developments that must share in the implementation and/or in the improvement of the integration of the invention within the service or within the Website concerned (technical environment, software or other application already present) depending on the specifications of the client.

Since the technical processes of the second group vary intrinsically according to the technical environment or the specifications of the client, we will accordingly develop here only the technical processes belonging to the first group.

Since the object of the invention is to resize the elements of a service or of a Website depending on the resolution of the screen where the latter would be displayed, the application of a coefficient multiplier to these elements (to be determined for each screen definition) is therefore necessary. Since Websites are based on standard screens with a resolution of 1024×768 pixels, we will take this figure as base 1 so as to obtain the ratios to be applied for each screen resolution encountered on the market.

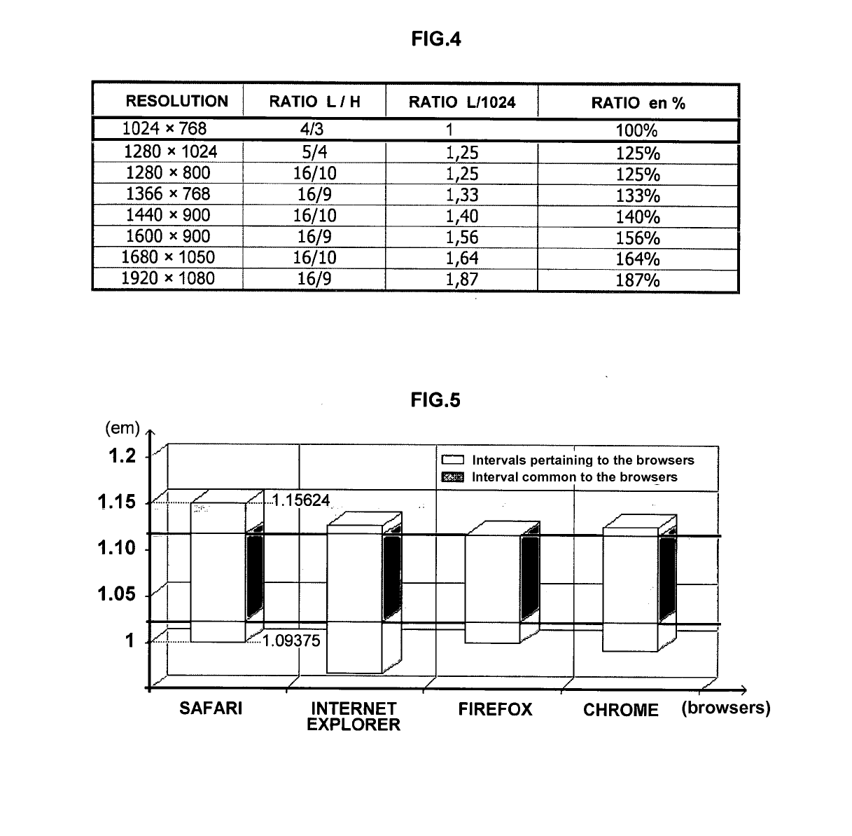

The table in FIG. 4 shows us the results obtained for the different definitions. Once these coefficients have been determined, the application of the latter to each element of the service or of the Website depending on the resolution renders the process possible, although complex and tedious, since it would then be necessary to apply these coefficients to each element making up the pages of the service or Website concerned.

We must therefore make this process automatic in its operation, but also in its installation, so that using it requires no knowledge or technical intervention on the part of the client.

Since the objective is to make our HD-Web™ portable and nonintrusive regardless of the technical environment where the latter will be implemented, so as to be able to offer the following services:
A standardization of the Websites that do not support high definition (i.e., for all those have been initially developed for a screen resolution of 1024×768 pixels) without the client having to redo his entire site.
A standardization of the services and Websites that have not developed a solution that makes possible the publishing of high-definition contents and of standard contents coexisting effectively within the same publishing platform, without having to modify the already existing installation.
The migration and/or the design of high-definition compatible services or Websites on all technical environments regardless of the platform, the Framework, the API, or the language used by this service or this Website.
The migration and/or the design of high-definition compatible services or Websites for clients that cannot or do not want to give access to the source files of their service or their website for contractual, financial or confidentiality reasons.

Since this above characteristic is essential, considering a large number of clients are not the hosts of their own Websites (in the usual case when they have subcontracted the design and/or the maintenance thereof and find themselves bound contractually), or else when the services or Websites are managed by content management systems known as CMS (Content Management System) that all use a process for updating and adding content that belongs to them.

This is why the following technical processes, as well as all those mentioned in this invention, have been developed specifically to respond to these problems, so as to render our HD-Web™ application separate, portable, and nonintrusive, regardless of the technical environment of the service or the Website where the latter will be implemented.

All of the technical processes thus developed for this invention have been grouped together in three categories for greater comprehension:
1.) The first category grouping together all of the technical methods responsible for selectively collecting, on the client-side, the elements present in the pages of the service or the Website concerned (step 1), so as to store their attributes in memory—an attribute being a property of forming an element—(step 2), before applying to them one of the coefficient multipliers of the table in FIG. 4 (step 3), and to resize their size according to the size of the screen on which the latter would be displayed (step 4), finally to replace them with identical elements but whose attributes have been defined for this new size (step 5).
2.) The second category grouping together all of the server-side technical processes that intervene in the resizing of each element (step 1), according to the screen sizes defined previously by the client base by a process that is able to have its parameters set (step 0), then grouping together the elements and the attributes thus created, in dedicated files and/or directories according to their element category and the screen size for which they are intended (step 2).
3.) Finally, the third category grouping together the technical processes making it possible for the application located on the server-side to communicate with the Web browser located on the client-side, by functions using Boolean values (step 1), grouping together each screen size within unique variables (step 2) themselves grouped together in a single initialization function (step 3).

This function will then be able to be called at any time to communicate in real time to the server what files must be sent to the browser depending on the screen size on which the latter are going to be viewed, this so that the Web server sends only the files corresponding to this size, for optimizing the loading speed of the pages of the service or Website in question.

Once these processes have been applied to all of the attributes of the elements of the pages belonging to the same category, we will be able to proceed in an identical manner for all of the attributes of the elements of the other categories that have been defined in the contents of the pages of the service or Website in question.

Since the technical processes used vary slightly according to the categories of elements to which the latter are applied, rather than explaining each of them in detail again as we have done previously, rather we will explain the generic process used to modify the group of the attributes of the elements of all of the categories that have been defined apart from the contents of the pages of the service or Website in question.

It will involve technical processes that we will group together in a fourth and final category and that will be responsible for going through all of the files whose attributes have been defined for a resolution of 1024×768 pixels (step 1), so as to apply to them the coefficient multipliers defined in the table of FIG. 4 (step 2), but this time by taking into consideration the differences in details between the browsers on the market when these dimensions have been defined in em quad (em)—an em being, in contrast with the pixel, a relative unit dependent on the font and on the precision of the browser using it (see FIG. 5).

Then, as we have done previously, the attributes of the elements thus newly defined will be grouped together and generated, either in a single directory corresponding to them, or in the same directory after having been renamed (step 3) to then be sent by the Web server depending on the screen resolution detected by our application (step 4), thanks to the technical processes belonging to the third category.

Finally, the last step of this process (step 5) will dynamically eliminate, i.e., without touching the original files, all of the attributes of the elements defined for a screen resolution of 1024 pixels wide, as well as all of the elements making reference there, to replace them with instructions calling specific files stored on the server by our application and defined for the resolution of the screen on which the service or Website is actually viewed (step 6).

All of these above modifications taking place, once again, without it having been necessary to touch the source files of the service or Website hosting this solution.

Our HD-Web™ application requiring simply to be uploaded on the host Web server, or else on a remote dedicated Web server, this for saving the load of the service or Website in question, which will then be able to take advantage of this invention without lowering of its own performance nor considering the constraints connected with the different sizes of screens present on the market and ensuring at the same time a compatibility and a lasting utilization thereof, regardless of the evolution of the equipment and publishing standards in the future.

1-11. (canceled)

12. Process of interaction between a server publishing contents from the Internet of the service or web site type, and a client displaying these contents in a browser interface and on a screen, in particular a large-size screen or a high-definition HD screen, characterized in that the method located on said server displays and dynamically modifies these contents proportionally to the size and definition of the screens on which they are displayed.

13. Process according to claim 12, wherein it returns the definition of the screen used by said client to the said server, and wherein the displaying and modifying of said contents takes place in real time, dynamically and proportionally to the definition returned, by the application of operations maintaining a constant relation between the proportions of these contents and the screens on which they are displayed.

14. Process according to claim 12, wherein it comprises a step consisting in modifying said contents, and in particular the attributes of the elements of these contents—an attribute being a property of an element and an element a property defining a type of content in a web page—by generating new attributes calculated and specifically redefined for the size and the definition of the screens on which these contents will be displayed.

15. Process according to claim 14, wherein it comprises a step consisting in generating said new attributes of said contents by replacing their former values with new ones calculated according to a coefficient multiplier that modifies their properties according to the size and the definition of the screens on which these contents will be displayed.

16. Process according to claim 14, wherein it comprises a step consisting in generating said new attributes of said contents by replacing them with attributes of contents themselves generated according to properties specifically defined for the size and the definition of the screens on which these contents will be displayed.

17. Process according to claim 16, wherein it runs in real time after the sending of said contents from said server when it involves modifying them, so that the modification of said contents takes place without necessitating their return and calling for their resending to said server and said client.

18. Process according to claim 14, wherein it runs before the sending of said contents from said server when it involves replacing them, so that the replacement of said contents takes place without necessitating their return and calling for their resending to said server and said client.

19. Process according to claim 12, wherein it collects, stores, and generates said contents in memory and in cache on said server and with said client, and in particular the attributes of the elements of said contents to be modified and replaced, so that the modification and the replacement of these contents is done in real time when they are broadcast, independently of the transfer speed of the networks where these contents are broadcast.

20. Process according to claim 12, wherein its use takes place:
automatically, i.e., independently of the user, the system or the program that broadcasts and displays these contents,
in real time, i.e., without slowing down the system, or the program that broadcasts and displays these contents.

21. Computer program product, Framework or Library, making possible the use of the process, according to claim 12.

22. System making possible the use of the process according to claim 12.

23. Process according to claim 15, wherein it runs before the sending of said contents from said server when it involves replacing them, so that the replacement of said contents takes place without necessitating their return and calling for their resending to said server and said client.
